(19) United States
(12) Patent Application Publication
(10) Pub. No.: US 2006/0215045 A1
(43) Pub. Date: Sep. 28, 2006

(54) Digital camera, image playback apparatus, methods of controlling same, and program for controlling image playback apparatus

(75) Inventor: Makoto Ooishi, Asaki-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/386,669

(22) Filed: Mar. 23, 2006

(30) Foreign Application Priority Data
Mar. 24, 2005 (JP) 2005-085337

(51) Int. Cl. H04N 5/76; H04N 5/217

(52) U.S. Cl. 348/231.7; 348/241

(57) ABSTRACT

CCD-RAW image data is obtained from a CCD by sensing the image of a subject. The CCD-RAW image data has noise that is specific to the CCD removed in a offset/flaw-correcting circuit and noise reducing circuit, whereby first color mage data is obtained. The first color image data is recorded on a memory card together with signal processing information indicating that the CCD-specific noise has been reduced. At the time of image playback, processing other than the processing for reducing the CCD-specific noise, namely first color correcting processing, tone correcting processing, second color correction processing and data compression processing is executed based upon the signal processing information. Since the processing for reducing the CCD-specific noise has been executed, this processing is no longer necessary at the time of image playback and information pertaining to the CCD that was used when the CCD-RAW image data was obtained need not be applied to an image playback apparatus.

### BACKGROUND OF THE INVENTION

1. Field of the Invention

This invention relates to a digital camera (inclusive of a portable information device having the function of a digital camera), an image playback apparatus, methods of controlling the camera and apparatus, and a program that controls the image playback apparatus.

2. Description of the Related Art

A digital still camera capable of recording CCD-RAW image data, which has not undergone data compression and the like, on a memory card in order to obtain a high-quality image has been contemplated (see the specification of Japanese Patent Application Laid-Open No. 2001-61067). By inserting the memory card on which the CCD-RAW image data has been recorded into a personal computer, the CCD-RAW image data can be subjected to various signal processing in the personal computer.

However, there is also signal processing that is better executed by the digital camera.

### DISCLOSURE OF THE INVENTION

Accordingly, an object of the present invention is to so arrange it that signal processing suited to a digital camera is executed by the digital camera.

According to a first aspect of the present invention, the foregoing object is attained by providing a digital camera comprising: a solid-state electronic image sensing device for sensing the image of a subject and outputting CCD-RAW image data that represents the image of the subject; a noise reducing circuit for reducing noise, which is specific to the solid-state electronic image sensing device, from the CCD-RAW image data that has been output from the solid-state electronic image sensing device; and a recording control device for recording the CCD-RAW image data, in which the noise specific to the solid-state electronic image sensing device has been reduced in the noise reducing circuit, on a recording medium removably loaded in the digital camera.

The first aspect of present invention also provides a control method suited to the digital camera described above. More specifically, the present invention provides a method of controlling a digital camera, comprising the steps of: sensing the image of a subject using a solid-state electronic image sensing, device and obtaining CCD-RAW image data that represents the image of the subject; reducing noise, which is specific to the solid-state electronic image sensing device, from the CCD-RAW image data that has been output from the solid-state electronic image sensing device; and recording the CCD-RAW image data, in which the noise specific to the solid-state electronic image sensing device has been reduced, on a recording medium removably loaded in the digital camera.

In accordance with the first aspect of the present invention, CCD-RAW image data representing the image of a subject is obtained by sensing the image of the subject using a solid-state electronic image sensing device with which a digital camera is provided. Noise specific to the solid-state electronic image sensing device is reduced from the obtained CCD-RAW image data. The CCD-RAW image data in which this specific noise has been reduced is recorded on a recording medium removably loaded in the digital camera. The noise specific to the solid-state electronic image sensing device also includes random noise which, if it is specific to the solid-state electronic image sensing device, is not uniform from one device to the next.

If the processing for reducing noise specific to a solid-state electronic image sensing device were to be executed in a personal computer, then it would be necessary for information pertaining to the solid-state electronic image sensing device to be written to the recording medium. In accordance with the first aspect of the present invention, the processing for reducing noise specific to the solid-state electronic image sensing device is executed by a digital camera rather than by a personal computer. Since information pertaining to the solid-state electronic image sensing device provided in the digital camera can be recognized in the digital camera, noise specific to the solid-state electronic image sensing device can be reduced comparatively simply in the noise reducing circuit.

The recording control device may be one that records on the recording medium the CCD-RAW image data in which the specific noise has been reduced as well as information indicating that the CCD-RAW image data in which the specific noise has been reduced has been recorded on the recording medium.

According to a second aspect of the present invention, the foregoing object is attained by providing a digital camera comprising: a solid-state electronic image sensing device for sensing the image of a subject and outputting CCD-RAW color image data that represents the color image of the subject; a noise reducing circuit for reducing noise, which is specific to the solid-state electronic image sensing device, from the CCD-RAW color image data that has been output from the solid-state electronic image sensing device, and outputting first color image data in which noise has been reduced; a color correcting circuit for applying a color correction to the first color image data that has been output from the noise reducing circuit and outputting second color image data that has undergone the color correction; a tone correcting circuit for applying a tone correction to the second color image data that has been output from the color correcting circuit and outputting third color image data that has undergone the tone correction; a selecting device for selecting image data, which is to be recorded on a recording medium removably loaded in the digital camera, from among the CCD-RAW image data, the first color image data, the second color image data and the third color image data; and a recording control device for recording the image data that has been selected by the selecting device and information, which indicates the details of image processing that has been applied to the selected image data, on the removable recording medium.

The second aspect of present invention also provides a control method suited to the digital camera described above. More specifically, the present invention provides a method of controlling a digital camera having a solid-state electronic image sensing device for sensing the image of a subject and outputting CCD-RAW color image data that represents the color image of the subject, a noise reducing circuit for reducing noise, which is specific to the solid-state electronic image sensing device, from the CCD-RAW color image data that has been output from the solid-state electronic image sensing device, and outputting first color image data in which noise has been reduced, a color correcting circuit for applying a color correction to the first color image data that has been output from the noise reducing circuit and outputting second color image data that has undergone the color correction, and a tone correcting circuit for applying a tone correction to the second color image data that has been output from the color correcting circuit and outputting third color image data that has undergone the tone correction, the method comprising the steps of: selecting image data, which is to be recorded on a recording medium removably loaded in the digital camera, from among the CCD-RAW image data, the first color image data, the second color image data and the third color image data; and recording the image data that has been selected and information, which indicates the details of image processing that has been applied to the selected image data, on the removable recording medium.

In accordance with the second aspect of the present invention, CCD-RAW color image data, first color image data from which noise specific to the solid-state electronic image sensing device has been removed, second color image data that has undergone a color correction and third color image data that has undergone a tone correction is obtained. Image data to be recorded on a recording medium removably loaded in a digital camera is selected from among the CCD-RAW color image data, first color image data, second color image data and third color image data. The selected image data is recorded on the recording medium.

In accordance with the second aspect of the present invention, desired color image data from among CCD-RAW color image data, first color image data, second color image data and third color image data can be recorded on a recording medium removably loaded in a digital camera. Image data that has undergone processing suited to the digital camera can be recorded on the recording medium.

According to a third aspect of the present invention, the foregoing object is attained by providing an image playback apparatus comprising: a reading device for reading a recording medium removably loaded in a digital camera and on which have been recorded CCD-RAW color image data, first color image data in which noise has been reduced from the CCD-RAW color image data by noise reducing processing, second color image data obtained as a result of subjecting the first color image data to a color correction by color correcting processing, or third color image data obtained as a result of subjecting the second color image data to a tone correction by tone correcting processing, wherein information indicating details of processing that has been applied to image data recorded on the recording medium from among the CCD-RAW color image data, first color image data, second color image data and third color image data has been recorded on the recording medium, the reading device reading the image data and the information indicating details of processing from the recording medium; and a data processing device for subjecting the image data, which has been read by the reading device, to whichever of the noise reducing processing, color correcting processing and tone correcting processing has not been executed, based upon the information, which has been read by the reading device, indicating details of processing.

The third aspect of present invention also provides a control method suited to the image playback apparatus described above. More specifically, the present invention provides a method of controlling an image playback apparatus comprising the steps of: a reading step of reading a recording medium removably loaded in a digital camera and on which have been recorded CCD-RAW color image data, first color image data in which noise has been reduced from the CCD-RAW color image data by noise reducing processing, second color image data obtained as a result of subjecting the first color image data to a color correction by color correcting processing, or third color image data obtained as a result of subjecting the second color image data to a tone correction by tone correcting processing, wherein information indicating details of processing that has been applied to image data recorded on the recording medium from among the CCD-RAW color image data, first color image data, second color image data and third color image data has been recorded on the recording medium, the reading step reading the image data and the information indicating details of processing from the recording medium; and subjecting the read image data to whichever of the noise reducing processing, color correcting processing and tone correcting processing has not been executed, based upon the read information indicating details of processing.

The third aspect of the present invention also provides a program for controlling the image playback apparatus described above.

In accordance with the third aspect of the present invention, the CCD-RAW color image data, first color image data, second color image data or third color image data is recorded on a recording medium as well as the details of processing that has been applied to the recorded image data. The image data that has been read from the recording medium is subjected to whichever of the noise reducing processing, color correcting processing and tone correcting processing has not been executed.

Thus, processing that has not been applied to the image data that has been recorded on the recording medium can be processed in the image playback apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of a digital still camera according to an embodiment of the present invention;

FIG. 2 is a block diagram illustrating the electrical structure of a signal processing circuit in this embodiment of the present invention;

FIG. 3 illustrates the data organization of a memory card in this embodiment;

FIG. 4 is a flowchart illustrating recording processing executed by the digital still camera according to this embodiment;

FIG. 5 is a block diagram illustrating the electrical structure of an image playback apparatus according to an embodiment of the present invention; and

FIG. 6 is a flowchart illustrating playback processing executed by the image playback apparatus of the embodiment.

### DESCRIPTION OF THE PREFERRED EMBODIMENT

A preferred embodiment of the present invention will now be described in detail with reference to the drawings.

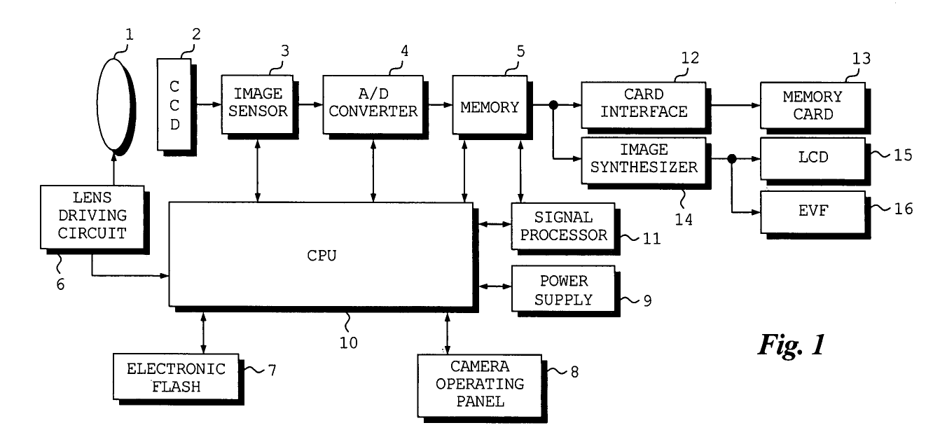

FIG. 1 is a block diagram of an embodiment of the present invention and illustrates the electrical structure of a digital still camera.

The digital still camera according to this embodiment is capable of storing image data, which has been subjected to signal processing of a desired stage among a plurality of stages of signal processing, on a memory card. Which image data, which has undergone signal processing up to a particular stage, is to be recorded on a memory card 13 is specified by the user using a selection switch included on a camera operating panel 8. The camera operating panel 8 further includes a mode setting switch for setting a mode such as a shooting mode or playback mode, and a shutter-release button. The operating signal that is output from the camera operating panel 8 is input to a CPU 10.

The digital still camera also includes an electronic-flash light-emission unit 7 for flash photography. A power supply circuit 9 for supplying the circuits of the digital still camera with electric power also is connected to the CPU 10.

If the shooting mode is set, an imaging lens 1 is controlled by a lens driving circuit 6 so that the image of the subject is formed on the photoreceptor surface of a CCD 2. A video signal representing the image of the subject is output from the CCD 2 is input to an image sensing circuit 3. The latter executes prescribed signal processing such as correlated double sampling. The video signal that has been output from the image sensing circuit 3 is converted to digital CCD-RAW image data in an analog/digital converting circuit 4. The CCD-RAW image data simply passes through a memory 5 and is input to a signal processing circuit 11. The latter executes simple processing (a white balance adjustment and synchronization, etc.) for a through-image display.

The image data that has been output from the signal processing circuit 11 is applied to a liquid crystal display unit 15 and electronic viewfinder 16 via an image synthesizing circuit 14. The image of the subject is displayed on the display screen of the liquid crystal display unit 15 and on the display screen or the electronic viewfinder 16.

If the shutter-release button is pressed, recording processing is executed in the signal processing circuit 11 in a manner described below. Image data that has been output from the signal processing circuit 11 is applied to and stored temporarily in the memory 5. The image data is applied to and recorded on the memory card 13, which is removably inserted into the digital still camera, via a card interface 12.

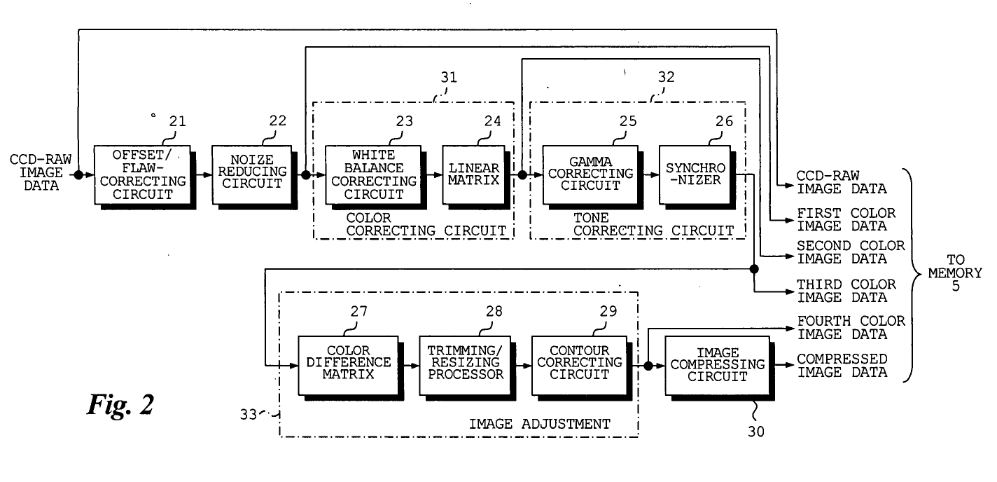

FIG. 2 is a block diagram illustrating the electrical structure of the signal processing circuit 11. FIG. 2 illustrates the processing blocks for recording; blocks for executing simple processing to merely pass and display an image have been deleted.

The CCD-RAW image data that has been output from the analog/digital converting circuit 4 is subjected to CCD offset processing and to flaw correction processing in an offset/flaw-correcting circuit 21 and the resultant data is input to a noise reducing circuit 22. Random noise specific to the CCD 2 is removed from the CCD-RAW image data in the noise reducing circuit 22. Noise specific to the CCD 2 provided in the digital still camera is eliminated by the offset/flaw-correcting circuit 21 and noise reducing circuit 22.

The CCD-RAW image data from which noise specific to the CCD 2 has been removed by the noise reducing circuit 22 is input as first color image data to a white balance correcting circuit 23 that constructs a color correcting circuit 31. The white balance of the first color image data is corrected in the white balance correcting circuit 23. The first color image data that has undergone the white balance correction is subjected to a color correction in a linear matrix circuit 24 and is output from the color correcting circuit 31 as second color image data.

The second color image data that has been output from the color correcting circuit 31 is gamma-corrected in a gamma correcting circuit 25 that constructs a tone correction circuit 32. The gamma-corrected second color image data is subjected to synchronization processing in a synchronizing circuit 26 and is output from the tone correction circuit 32 as third color image data.

The third color image data that has been output from the tone correction circuit 32 is input to a color difference matrix circuit 27 that constructs an image adjusting circuit 33. The coloring of the image is finely adjusted by the color difference matrix circuit 27. The third color image data that has been output from the color difference matrix circuit 27 is subjected to trimming processing and resizing processing to a prescribed size in a trimming/resizing processing circuit 28. The third color image data that has been subjected to the trimming processing and resizing processing in the trimming/resizing processing circuit 28 is subjected to contour correction processing in a contour correcting circuit 29 in such a manner that the contour of the image is emphasized. The output from the contour correcting circuit 29 becomes the output of the image adjusting circuit 33 and is applied to an image compressing circuit 30 as fourth color image data.

The fourth color image data that has been output from the image adjusting circuit 33 is subjected to data compression in the image compressing circuit 30 and is output as compressed image data.

Thus, in accordance with a selection made by the user, the signal processing circuit 11 outputs the CCD-RAW image data, first color image data, second color image data, third color image data, fourth color image data or compressed image data. The image data that has been output from the signal processing circuit 11 is applied to and recorded on the memory card 13 via the memory 5, as mentioned above. Further, in the digital still camera according to this embodiment, signal processing information also is recorded on the memory card 13. The signal processing information indicates whether the image data that has been recorded on the memory card 13 is the CCD-RAW image data, data that has undergone processing to reduce noise specific to the CCD 2 (namely the first color image data), data that has undergone processing to reduce noise specific to the CCD 2 as well as color correcting processing in the color correcting circuit 31 (namely the second color image data), data that has undergone processing to reduce noise specific to the CCD 2, color correcting processing in the color correcting circuit 31 and tone correcting processing in the tone correction circuit 32 (namely the third color image data), data that has undergone processing to reduce noise specific to the CCD 2, color correcting processing in the color correcting circuit 31, tone correcting processing in the tone correction circuit 32 and image adjusting processing in the image adjusting circuit 33 (namely the fourth color image data), or data that has undergone processing to reduce noise specific to the CCD 2, color correcting processing in the color correcting circuit 31, tone correcting processing in the tone correction circuit 32, image adjusting processing in the image adjusting circuit 33 and data compressing processing in the image compressing circuit 30 (namely the compressed image data).

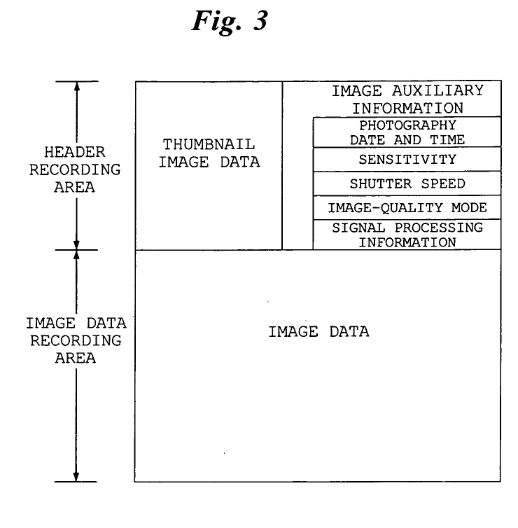

FIG. 3 illustrates the data organization of the memory card 13.

The memory card 13 has an image data recording area and a header recording area.

Whichever image data that has been selected by the user from among the CCD-RAW image data, first color image data, second color image data, third color image data, fourth color image data and compressed color image data in the manner described above is recorded in the image data recording area. It may of course be so arranged the multiple items of image data are recorded per frame.

Information such as for managing the memory card 13 is recorded in the header recording area. More specifically, thumbnail image data representing a thumbnail image of the image of a subject that is represented by the image data that has been recorded in the image data recording (the thumbnail image data can be generated by downsampling image data stored temporarily in the memory 5) and image auxiliary information are recorded in the header recording area. The image auxiliary information is date and time of photography, sensitivity, shutter speed, image-quality mode and the above-mentioned signal processing information.

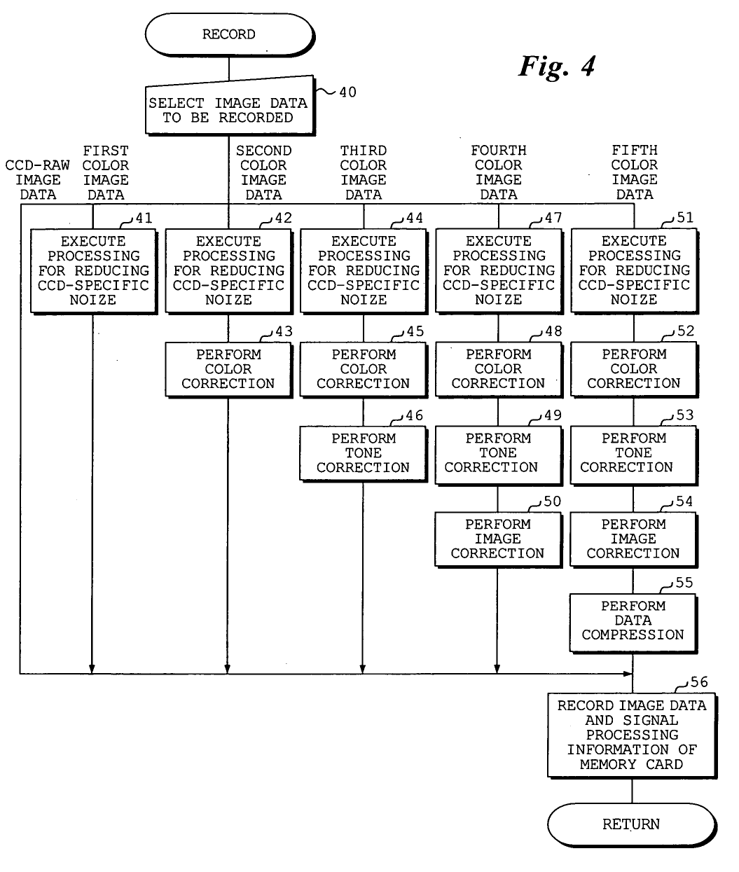

FIG. 4 is a flowchart illustrating recording processing executed by the digital still camera.

First, the image data to be recorded on the memory card 13 is selected by the user.

If the CCD-RAW image data has been selected, then the CCD-RAW image data that has been output from the analog/digital converting circuit 4 is applied to the memory card 13 and recorded together with the signal processing information in the manner described above (step 56).

If the first color data has been selected, then the CCD-RAW image data is subjected to noise reducing processing in the offset/flaw-correcting circuit 21 and in the noise reducing circuit 22 (step 41). As a result, processing for reducing noise specific to the CCD 2 is applied and first color image data is obtained. The first color image data is recorded on the memory card 13 together with the signal processing information (step 56).

If the second color data has been selected, then processing (step 42) for reducing noise specific to the CCD 2 is executed and color correcting processing is executed in the color correcting circuit 31 to obtain second color image data (step 43). The second color image data is recorded on the memory card 13 together with the signal processing information (step 56).

If the third color data has been selected, then processing (step 44) for reducing noise specific to the CCD 2, color correcting processing (step 45) and tone correcting processing (step 46) in the tone correction circuit 32 is executed to obtain third color image data. The obtained third color image data is recorded on the memory card 13 together with the signal processing information (step 56).

If the fourth color data has been selected, then processing (step 47) for reducing noise specific to the CCD 2, color correcting processing (step 48), tone correcting processing (step 49) and image adjusting processing (step 50) in the image adjusting circuit 33 (step 50) is executed to obtain fourth color image data. The obtained fourth color image data is recorded on the memory card 13 together with the signal processing information (step 56).

If the compressed image data has been selected, then processing (step 51) for reducing noise specific to the CCD 2, color correcting processing (step 52), tone correcting processing (step 53), image adjusting processing (step 54) and data compression processing in the image compressing circuit 30 is executed to obtain compressed image data. The obtained compressed image data is recorded on the memory card 13 together with the signal processing information (step 56).

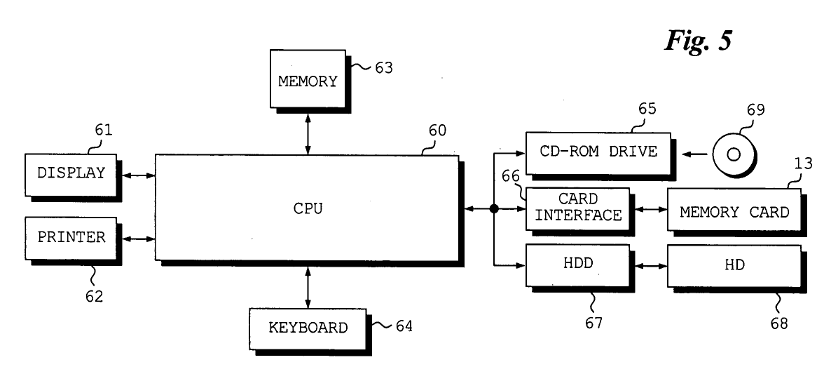

FIG. 5 is a block diagram illustrating the electrical structure of an image playback apparatus (personal computer).

The operation of the overall image playback apparatus is controlled by a CPU 60.

The image playback apparatus includes a display unit 61 for displaying images, a printer 62 for printing images, a memory 63 for storing data temporarily, and a keyboard 64. The image playback apparatus further includes a CD-ROM (Compact Disk-Read-Only Memory) drive 65 for reading programs and data, etc., that have been recorded on a CD-ROM. By reading a program, which has been recorded on the CD-ROM 69, by the CD-ROM drive 65, the image playback apparatus operates in a manner described later. The image playback apparatus further includes a memory card interface 66 for reading the memory card 13, etc., on which image data and signal processing information, etc., has been recorded by the digital still camera, as set forth above, as well as a hard disk 68 and hard-disk drive 67.

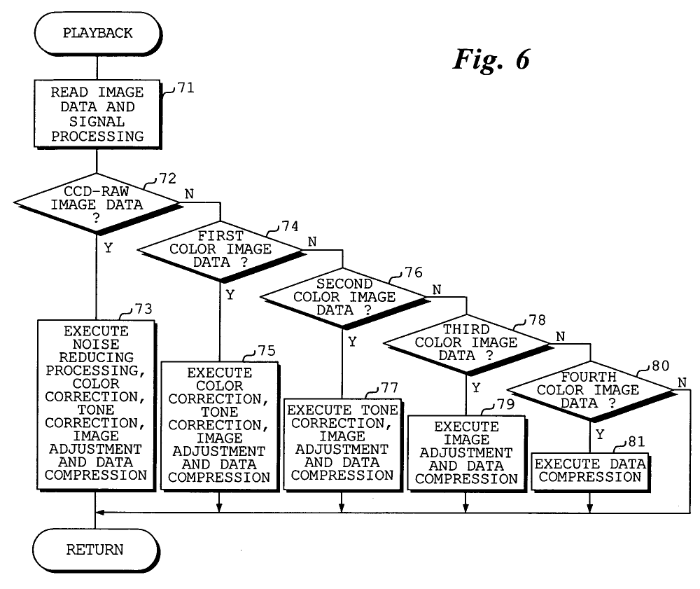

FIG. 6 is a flowchart illustrating processing executed by the image playback apparatus.

Described next will be processing in a case where the memory card 13, on which image data and signal processing information, etc., have been recorded by a digital still camera as set forth above, has been loaded in the image playback apparatus.

When the memory card 13 is loaded in the image playback apparatus and an image to be played back is designated by the user, the image data representing the designated image and the signal processing information corresponding to this image are read from the memory card 13 (step 71). On the basis of the signal processing information read, it is determined whether the image data representing the image designated by the user is CCD-RAW image data (step 72), first color image data (step 74), second color image data (step 76), third color image data (step 78), fourth color image data (step 80) or compressed image data (step 82).

If the image data is CCD-RAW image data (“YES” at step 72), then processing for reducing noise specific to the CCD 2, color correcting processing, tone correcting processing, image adjusting processing and data compression processing has not been executed and therefore the noise reducing processing, color correcting processing, tone correcting processing, image adjusting processing and data compression processing is carried out (step 73). Since the image playback apparatus cannot recognize what kind of CCD was used to obtain the CCD-RAW image data, information regarding the manufacturer name and model, etc. of the CCD would be recorded on the memory card 13 by the digital still camera in correspondence with the image that has been designated as the image to be played back. Processing for reducing noise specific to the CCD is performed based upon the information pertaining to the CCD.

If the image data is the first color image data (“YES” at step 74), this means that although processing for reducing noise specific to the CCD 2 has been executed, color correcting processing, tone correcting processing, image adjusting processing and data compression processing has not been executed and therefore the color correcting processing, tone correcting processing, image adjusting processing and data compression processing is carried out (step 75).

If the image data is the second color image data (“YES” at step 76), this means that although processing for reducing noise specific to the CCD 2 and color correcting processing has been executed, tone correcting processing, image adjusting processing and data compression processing has not been executed and therefore the tone correcting processing, image adjusting processing and data compression processing is carried out (step 77).

If the image data is the third color image data (“YES” at step 78), this means that although processing for reducing noise specific to the CCD 2, color correcting processing and tone correcting processing has been executed, image adjusting processing and data compression processing has not been executed and therefore the image adjusting processing and data compression processing is carried out (step 79).

If the image data is the fourth color image data (“YES” at step 80), this means that although processing for reducing noise specific to the CCD 2, color correcting processing, tone correcting processing and image adjusting processing has been executed, data compression processing has not been executed and therefore the data compression processing is carried out (step 81).

If the image data is the compressed image data (“YES” at step 82), this means that processing for reducing noise specific to the CCD 2, color correcting processing, tone correcting processing, image adjusting processing and data compression processing has been executed and therefore these types of processing are not executed again.

Thus, processing that has not been executed by a digital still camera is performed in an image playback apparatus and the processed image data is played back (displayed or printed) thereby.

As many apparently widely different embodiments of the present invention can be made without departing from the spirit and scope thereof, it is to be understood that the invention is not limited to the specific embodiments thereof except as defined in the appended claims.

What is claimed is:

1. A digital camera comprising:
a solid-state electronic image sensing device for sensing the image of a subject and outputting CCD-RAW image data that represents the image of the subject;
a noise reducing circuit for reducing noise, which is specific to said solid-state electronic image sensing device, from the CCD-RAW image data that has been output from said solid-state electronic image sensing device; and
a recording control device for recording the CCD-RAW image data, in which the noise specific to said solid-state electronic image sensing device has been reduced in the noise reducing circuit, on a recording medium removably loaded in the digital camera.

2. The camera according to claim 1, wherein said recording control device records on the recording medium the CCD-RAW image data in which the specific noise has been reduced as well as information indicating that the CCD-RAW image data in which the specific noise has been reduced has been recorded on the recording medium.

3. A digital camera comprising:
a solid-state electronic image sensing device for sensing the image of a subject and outputting CCD-RAW color image data that represents the color image of the subject;
a noise reducing circuit for reducing noise, which is specific to said solid-state electronic image sensing device, from the CCD-RAW color image data that has been output from said solid-state electronic image sensing device, and outputting first color image data in which noise has been reduced;
a color correcting circuit for applying a color correction to the first color image data that has been output from said noise reducing circuit and outputting second color image data that has undergone the color correction;
a tone correcting circuit for applying a tone correction to the second color image data that has been output from said color correcting circuit and outputting third color image data that has undergone the tone correction;
a selecting device for selecting image data, which is to be recorded on a recording medium removably loaded in the digital camera, from among the CCD-RAW image data, the first color image data, the second color image data and the third color image data; and
a recording control device for recording the image data that has been selected by said selecting device and information, which indicates the details of image processing that has been applied to the selected image data, on the removable recording medium.

4. An image playback apparatus comprising:
a reading device for reading a recording medium removably loaded in a digital camera and on which have been recorded CCD-RAW color image data, first color image data in which noise has been reduced from the CCD-RAW color image data by noise reducing processing, second color image data obtained as a result of subjecting the first color image data to a color correction by color correcting processing, or third color image data obtained as a result of subjecting the second color image data to a tone correction by tone correcting processing, wherein information indicating details of processing that has been applied to image data recorded on the recording medium from among the CCD-RAW color image data, first color image data, second color image data and third color image data has been recorded on the recording medium, the reading device reading the image data and the information indicating details of processing from the recording medium; and
a data processing device for subjecting the image data, which has been read by said reading device, to whichever of the noise reducing processing, color correcting processing and tone correcting processing has not been executed, based upon the information, which has been read by the reading device, indicating details of processing.

5. A method of controlling a digital camera, comprising the steps of:
sensing the image of a subject using a solid-state electronic image sensing device and obtaining CCD-RAW image data that represents the image of the subject;
reducing noise, which is specific to the solid-state electronic image sensing device, from the CCD-RAW image data that has been output from the solid-state electronic image sensing device; and
recording the CCD-RAW image data, in which the noise specific to the solid-state electronic image sensing device has been reduced, on a recording medium removably loaded in the digital camera.

6. A method of controlling a digital camera having a solid-state electronic image sensing device for sensing the image of a subject and outputting CCD-RAW color image data that represents the color image of the subject, a noise reducing circuit for reducing noise, which is specific to the solid-state electronic image sensing device, from the CCD-RAW color image data that has been output from the solid-state electronic image sensing device, and outputting first color image data in which noise has been reduced, a color correcting circuit for applying a color correction to the first color image data that has been output from the noise reducing circuit and outputting second color image data that has undergone the color correction, and a tone correcting circuit for applying a tone correction to the second color image data that has been output from the color correcting circuit and outputting third color image data that has undergone the tone correction, said method comprising the steps of:
selecting image data, which is to be recorded on a recording medium removably loaded in the digital camera, from among the CCD-RAW image data, the first color image data, the second color image data and the third color image data; and
recording the image data that has been selected and information, which indicates the details of image processing that has been applied to the selected image data, on the removable recording medium.

7. A method of controlling an image playback apparatus comprising the steps of:
a reading step of reading a recording medium removably loaded in a digital camera and on which have been recorded CCD-RAW color image data, first color image data in which noise has been reduced from the CCD-RAW color image data by noise reducing processing, second color image data obtained as a result of subjecting the first color image data to a color correction by color correcting processing, or third color image data obtained as a result of subjecting the second color image data to a tone correction by tone correcting processing, wherein information indicating details of processing that has been applied to image data recorded on the recording medium from among the CCD-RAW color image data, first color image data, second color image data and third color image data has been recorded on the recording medium, said reading step reading the image data and the information indicating details of processing from the recording medium; and
subjecting the read image data to whichever of the noise reducing processing, color correcting processing and tone correcting processing has not been executed, based upon the read information indicating details of processing.

8. A program for controlling an image playback apparatus so as to implement the following steps:
a reading step of reading a recording medium removably loaded in a digital camera and on which have been recorded CCD-RAW color image data, first color image data in which noise has been reduced from the CCD-RAW color image data by noise reducing processing, second color image data obtained as a result of subjecting the first color image data to a color correction by color correcting processing, or third color image data obtained as a result of subjecting the second color image data to a tone correction by tone correcting processing, wherein information indicating details of processing that has been applied to image data recorded on the recording medium from among the CCD-RAW color image data, first color image data, second color image data and third color image data has been recorded on the recording medium, said reading step reading the image data and the information indicating details of processing from the recording medium; and
subjecting the read image data to whichever of the noise reducing processing, color correcting processing and tone correcting processing has not been executed, based upon the read information indicating details of processing.
